(19) United States
(12) Patent Application Publication
(10) Pub. No.: US 2011/0010232 A1
(43) Pub. Date: Jan. 13, 2011

(54) MOBILE COMMUNICATION TECHNIQUES TO FACILITATE COMMERCIAL TRANSACTIONS

(76) Inventors: Sudhir M. Bhojwani, San Jose, CA (US); Sandeep M. Bhojwani, San Jose, CA (US); David H. Martin, San Jose, CA (US)

Correspondence Address: SCHEIN & CAI LLP;James Cai, 111 W. ST. JOHN ST., SUITE 1250, SAN JOSE, CA, 95113, US

(21) Appl. No.: 12/502,073

(22) Filed: Jul. 13, 2009

(51) Int. Cl. G06Q 30/00; G06Q 40/00; H04W 4/12

(52) U.S. Cl. 705/14.17; 455/466

(57) ABSTRACT

The present invention is directed to a method, implemented on an electronic communication network including a mobile telecommunications device, for providing financial incentives by associating the mobile telecommunications device with an incentive account; and messaging with the mobile telecommunications device in response to a predetermined trigger, with the messaging including information corresponding to a financial incentive provided through a financial account associated with the incentive account upon an occurrence of a desired commercial transaction satisfying predetermined criteria, and correlating information related to the financial account, incentive account, and occurrence of the desired commercial transaction, for further determination and action in awarding or withholding the financial incentive in accordance with the predetermined financial incentive criteria. Also disclosed is a system that operates in accordance with the method.

### BACKGROUND OF THE INVENTION

The present invention generally relates to commercial transactions communicated through an electronic communication network. More particularly, the present invention is directed to a method and system to incentivize the occurrence of commercial transactions using mobile communication devices.

Marketing of products and services has taken on new complexity in the digital age. The aggregation of wireless communication techniques with massive computer databases of detailed product and customer characteristics has provided business with resources for the systematic application of scientific and mathematical principles to achieve the goals of a particular sales process. This is often referred to as sales process engineering. An example of sales process engineering is the practice of financial institutions, such as credit card companies, banks, and merchants, offering incentives for purchases using the accounts of the financial institutions. The incentives may be in the nature of cash back on the account and/or accumulation of points that may be redeemed for products and/or services agreed to by the financial institution. The incentive provided, as well as the magnitude of the incentive, may be defined by the financial institution to favor certain merchants. For example some credit cards offer double points for every dollar spent at specific restaurants.

Taking advantage of the mobility provided by modern communication, merchants provide purchase incentives to mobile communication devices of prospective customers. These incentives are commonly referred to as mobile coupons and may be delivered using well known communication protocols: Short Message Service (SMS), Multimedia Message Service (MMS), WAP Push or mobile email. Access to the incentive typically requires validation. To that end, a mobile coupon will include information that facilitates validating, redeeming and tracking of the coupon, referred to as an offer code. For added security, the mobile coupons may require customer action before the offer code is delivered. Validation and redemption of the offer code occurs at a Point-of-Sale/Service (POS) system of the merchant that provided the offer code. Other restrictions may be associated with the offer code, e.g., the number of products, services and/or times a customer may receive the incentives associated with the offer code. The restrictions are typically enforced at the POS system.

A drawback with the prior art is the reliance upon a POS system to control the underlying commercial transaction of which the offer code is the subject. This may require establishing business relationships with many different merchants to ensure that the benefits provided by a coupon are received by the consumer. Additionally, many POS systems are incapable of performing the necessary functions that allow a customer to receive the incentives associated with a mobile coupon.

Therefore, a need exists, to provide mobile communication techniques that facilitate commercial transactions independent of POS systems.

### BRIEF SUMMARY OF THE INVENTION

The present invention is directed to a method, implemented on an electronic communication network including a mobile telecommunications device, for providing financial incentives by associating the mobile telecommunications device with an incentive account; and messaging with the mobile telecommunications device in response to a predetermined trigger, with the messaging including information corresponding to a financial incentive provided through a financial account associated with the incentive account upon an occurrence of a desired commercial transaction satisfying predetermined criteria. Upon completion of the desired commercial transaction satisfying the predetermined criteria, the servicer of the financial account, including a financial institution, may provide the financial incentive. This is typically done independent of the POS and/or provider of the products/services. Examples of the criteria include completing the desired commercial transaction within a predefined interval of travel time from the predetermined trigger, completing the desired commercial transaction with a payment of a value satisfying a predefined threshold amount; completing the desired commercial transaction at a predefined commercial establishment; and/or completing the desired commercial transaction a predefined number of times while satisfying the remaining criteria. The predetermined trigger may include passage of an interval of time, the occurrence of a calendar date and the like. These and other embodiments are discussed further below.

### BRIEF DESCRIPTION OF THE DRAWINGS

FIG. 1 is a plan view showing a system for communicating with a mobile telecommunications device, in accordance with the present invention;

FIG. 2 is a flow chart illustrating a method of messaging messages with a mobile telecommunications device to be informed of a financial incentive in accordance with the present invention;

FIG. 3 is a flow chart illustrating a method of sending reminder messages to a mobile telecommunications device to inform of expiration of a financial incentive in accordance with the present invention; and

FIG. 4 is a flow chart illustrating a method of messaging messages from a mobile telecommunications device to obtain a financial incentive in accordance with the present invention.

### DETAILED DESCRIPTION OF THE INVENTION

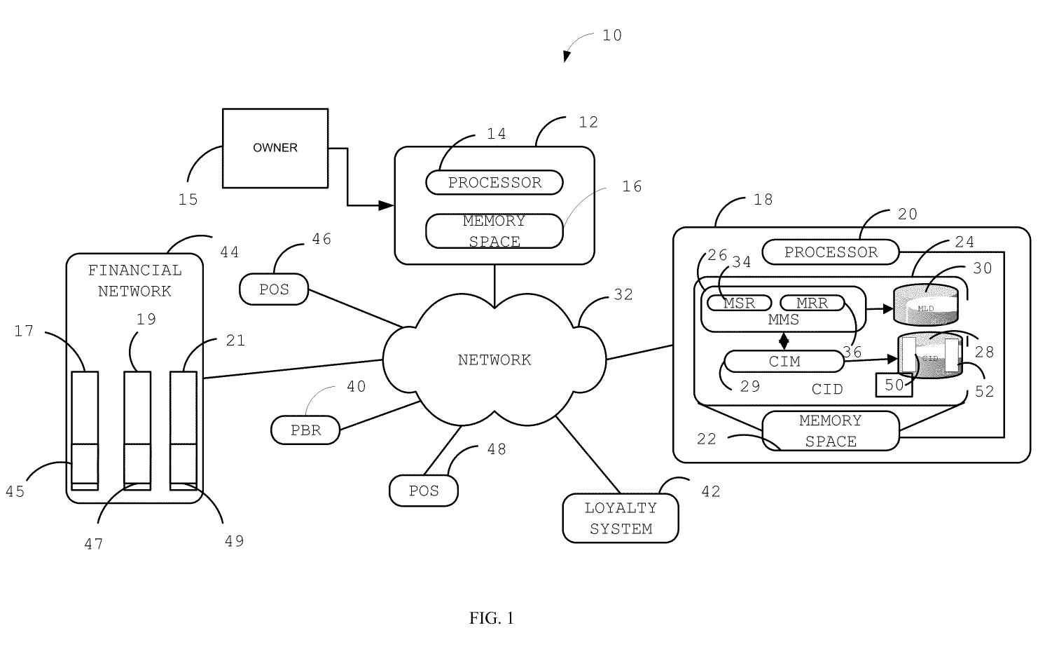

Referring to FIG. 1, a mobile communication system 10 includes a mobile telecommunications device (MTD) 12 having a processor 14 and a memory space 16. MTD 12 is associated with an owner 15. Memory space 16 includes computer readable code that when operated on by processor 14 functions to communicate with a commercial incentives server (CIS) 18. CIS 18 includes a processor 20 and a memory space 22. Memory space 22 includes computer readable code that when operated on by processor 20 functions as commercial incentive distributor (CID) 24. CID 24 includes a mobile message system (MMS) 26, a commercial incentives database CID 28, a commercial incentives manager (CIM) 29, and a message log database (MLD) 30. It should be noted that some of these systems may be external to CIS 18. As an example, CIS 18 may interface with an external or a third-party mobile messaging system (not shown) to provide the functionality of one or more of MMS 26, CID 28, CIM 29 and MLD 30. For ease of discussion, however, CIS 18 is shown as being an integrated system including all of MMS 26, CID 28, CIM 29 and MLD 30.

Messaging between MTD 12 and CIS 18 is typically achieved using a network 32, such as an electronic communication network. To that end, MMS 26 includes a mobile message sender routine (MSR) 34 and a mobile message receive routine (MRR) 36. MSR 34 interfaces with network 32 and functions to transmit and record messages to mobile device 12. To that end, MSR 34 records messages transmitted to mobile device 12 in MLD 30. MRR 36 interfaces with network 32 functions to receive messages from mobile device 12. MRR 36 employs information recorded in MLD 30 to process the messages. To facilitate communications between MTD 12 and CIS 18 MMS 26 may be configured to use known communication protocols, such as Short Message Service (SMS), Multimedia Message Service (MMS), WAP Push, or Email. This may be achieved, in part, by MSR 34 interfacing with a third-party aggregator system (not shown) capable of sending mobile messages.

CIS 18 facilitates communicating and/or providing commercial incentives between MTD 12 and parties with which the owner 15 of mobile device 12 has a business relationship, e.g., a financial institutions, such as a bank or a credit card company; a travel agency; an employer and the like, which are commonly referred to as pre-existing business relationships (PBR) 40. To that end, PBR 40, as well as a loyalty system 42, financial network 44 and merchant point of sale/service systems (POS) 46 and 48 are in data communication with electronic communication network 32. Loyalty system 42 may provide loyalty reward programs for PBRs 40 and may include point-based loyalty programs. Financial network 44 provides financial transaction processing and financial accounting systems, for financial institutions 17, 19 and 21, such as the case in which a consumer undertakes a commercial transaction employing a financial account, 45, 47 and 49 as represented by a credit card, debit card, and other financial institution issued cards at one or more POS 46 and 48. Although shown separate for clarity, CIS 18 may be incorporated into financial network 44. POS 46 and 48 are typically located at a merchant, where the product and/or service is provided in exchange for satisfaction by a user. To that end, POS 46 or 48 associates commercial transactions involving money between the parties acquiring the product and/or service and one of the financial accounts 45, 47 and 49 guaranteeing satisfaction to the merchant for the product and/or service.

Commercial transactions at POS 46 or 48 are typically processed through financial institutions 17, 19 and 21 and, optionally, loyalty system 42. In this manner, PBR 40 may reward a party associated therewith for commercial transactions that occur at POS 46 and 48, through correlation employing CIS 18. Specifically, PBR 40 and/or financial network 44 and/or loyalty system 42 may maintain a record of commercial activity for a party and provide rewards thereto such as by cash back and/or incentive offers that facilitate purchases of products and/or services for which cash-back may be received, resulting the products and/or services being obtained at a discounted price.

In addition to the aforementioned rewards, CIS 18 facilitates transmission and/or satisfaction of commercial incentives to users of MTD 12 based upon an event, referred to as a trigger. Trigger could be an occurrence of a calendar time or it could be occurrence of a financial transaction on financial account 45, 47 and 49. A PBR 40 using CIS 18 may provide to a user of MTD 12 information that functions as an incentive offer so that the owner of financial account 45, 47 and 49, after completing a commercial transaction at a given merchant's price for products and/or services, may obtain the same at an effectively discounted rate by receiving cash-back upon financial account 45, 47 and 49. To that end, CIM 29 maintains a record of incentive offers delivered to the MTD 12 on CID 28 and a record of communications with MTD 12 on MLD 30, corresponding to the incentive offers. To ensure that the proper incentive offer is transmitted to the appropriate MTD 12, CID 20 maintains information concerning one or more incentive accounts 50 and 52. Incentive accounts 50 and 52 associates MTD 12 with one or more of financial accounts 45, 47 and 49 and include information triggers that would initiate transmission of an incentive offer to MTD 12. Incentive accounts 50 and 52 also includes information concerning the commercial incentive which is provided by the incentive offer, e.g., cash-back to be credited to a financial account, as well as the criteria that a desired commercial transaction must satisfy in order for the financial incentive to be provided to the financial account 45, 47 and 49. The CIS 18 correlates information from the Financial Network 44 and the CID 24, based on predetermined criteria, to confirm financial incentives have been earned.

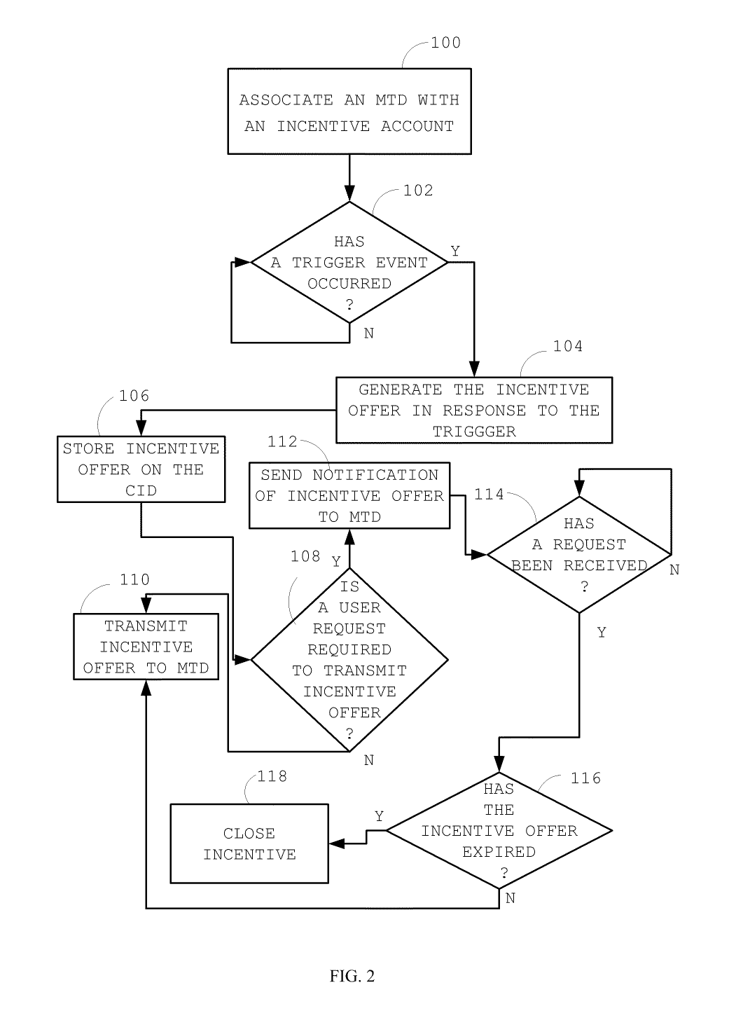

Referring to both FIGS. 1 and 2, in operation, CIS 18 associates MTD 12 with one or more incentive accounts 50 and 52, at step 100. Incentive account, in this example incentive account 50, includes information associating incentive offers, financial accounts 45, 47 and 49 and the communication device to which the incentive offers will be conveyed. In the present example, incentive offers are conveyed to MTD 12. However, it should be understood that other communication devices may be employed, a cellular telephone, a wireless hand held device, a mobile computing system using the e-mail system of the same or VoIP, a television and the like. Moreover, different financial accounts 45, 47 and 49 may use different communication devices and/or the particular communication device employed may be defined by the trigger. Alternatively, each incentive offer may be dedicated to delivery via a specific type of communications device.

Messaging between CIS 18 and MTD 12 occurs in response to a predetermined trigger. Information included in the messaging describes a financial incentive that may be provided via the financial account 17, 19 and 21 upon completion of a commercial transaction satisfying the predetermined criteria, referred to as a desired transaction. The desired transaction occurs after the trigger. The predetermined trigger may be any of several events. For example, the predetermined trigger may include passage of an interval of time or the occurrence of a calendar date, as well as occurrence of a financial transaction on the financial account 45, 47 and 49. CIS 22 determines whether an event trigger has occurred at step 102. Information related to the trigger, referred to as event information, may be received from PBR 40, loyalty system 42, and/or financial network 44. The event information includes information to facilitate generating the proper type of incentive offer, e.g., the information identifying the financial account 17, 19 or 21, employed to complete the transaction for the product/service, as well as the product/service purchased, the identity of the merchant, and the location of the merchant, as well as the amount used for purchase and the time of the purchase.

In response to a trigger, the incentive offer is generated to be transmitted to MTD 12, corresponding with the incentive account associated with the event information, at step 104. The event information included in the incentive offer describes the financial incentive that is provided and the criteria that a commercial transaction must satisfy in order for the financial incentive to be received, as well as, the originator of the incentive offer and the financial account upon which the financial incentive will be provided. For example, an incentive offer may be generated that requires purchase of a product/service that is associated with the timing of the event information. Were the purchase to occur around a holiday, the incentive offer may relate to the purchase of a product/service corresponding to the holiday. Alternatively, the incentive offer may be generated to facilitate purchase of a product/service corresponding to the product/service that was the subject of the event information. For example, purchase of clothing may result in generation of an incentive offer related to a complementary transaction, such as a purchase of another item of clothing from a specialty store associated with the same area, or mall or online instance of the specialty store.

Other criteria associated with the incentive offer may include completing the desired commercial transaction within a predefined interval of travel time from the trigger, completing the desired commercial transaction with a payment of a value satisfying predefined criteria, e.g., upon a certain minimum purchase amount. The criteria may include completing the desired commercial transaction at a predefined commercial establishment, e.g., STARBUCKS®, SEARS® or any commercial establishment within a shopping center, geographical area, or other selected demographic. The criteria may include completing the desired commercial transaction a predefined number of times while satisfying the remaining predefined criteria. For example, it may be that the incentive offer is for the purchase of a particular product multiple times at a certain merchant, such as coffee at STARBUCKS®. It should be understood that the aforementioned criteria is set forth singularly, however, any combination of the aforementioned criteria may be associated with an incentive offer.

Moreover, other criteria may be included in addition thereto, or in lieu thereof, such as criteria based upon a customer profile, event data, customer purchasing, and virtually any other criteria desired. For example, some criteria may be completely independent of the event that resulted in the trigger. A business relationship between the owner of CIS 18 and a particular financial account may be established with that and commercial transaction by another financial account may result in the generation of a financial offer. Assume, for example, that an owner of a VISA® financial account satisfies a commercial transaction user the VISA® financial account. The owner of CIS 18 may establish business relations with a servicer of a DISCOVER® financial account having the same owner as the aforementioned VISA® financial account. The nature of the business relations may be such that the services of the DISCOVER® financial account may have an incentive offer transmitted to the MTD 12 when the VISA® financial account is the subject of a commercial transaction.

At step 106, the incentive offer is stored on CID 28 as corresponding to the incentive account associated with MTD 12. At step 108, CIS 18 determines whether the incentive offer requires a request for the same from MTD 12, before conveying the incentive offer information thereto. If not, the incentive offer information is transmitted directly to MTD 12 at step 110. In response MTD 12 may notify the user thereof of the presence of the incentive offer using known techniques. Included in the incentive offer is information to facilitate the user of MTD 12 to take advantage of the commercial incentive evidenced by the incentive offer, the criteria that must be satisfied in order of the financial incentive to be received, as well as the financial account through which the financial incentive will be provided. An example of criteria based upon the foregoing example, is that the next two desired transaction be with the DISCOVER® financial account.

Were a request required in order for the incentive offer to be activated, step 112 occurs, during which MMS 26 transmits notification of the existence of the incentive offer to MTD 12. MTD 12 may notify the user thereof of the presence of the incentive offer notification through known techniques. Information included in the incentive offer notification may include all the information included in the incentive offer or subset thereof, e.g., information indicating the originator of the financial incentive and/or the criteria that must be satisfied to obtain the financial incentive and/or the nature of the financial incentives, just to name a few. Following step 112, step 114 occurs during which CIS 18 determines whether a request had been received from MTD 12. If not, step 114 loops until a request for the incentive offer is received from mobile telecommunications device 12. Upon receiving a request for the incentive offer, step 116 occurs during which CIS 18 determines whether the incentive offer has expired. If so the process closes the incentive, at step 118. Closing of the financial incentive in step 118 may involve messaging with the MTD 12 and updating information regarding the financial incentive in CID 28. Otherwise, step 110 occurs and MMS 26 transmits the incentive offer to MTD 12.

Typically, the owner of the financial account 45, 47 and 49 that corresponds to the incentive offer obtains the financial incentive directly to the financial account 45, 47 and 49. MTD 12 may or may not be associated with the financial account 45, 47 and 49 that provides the financial incentive. However, both MTD 12 and financial account 45, 47 and 49 are associated with a common incentive account 50. One advantage of the present invention is that the incentive offer is transparent to the merchants providing the sales/services, i.e., the party originating the incentive offer and the party receiving the benefits thereof are independent of the merchant that provides the sales/service that are the subject of the commercial transaction that results in the financial incentive. This provides greater flexibility for a PBR 40 to reward an owner of a financial account by vitiating the need to enter into separate agreements and/or transactions with individual merchants.

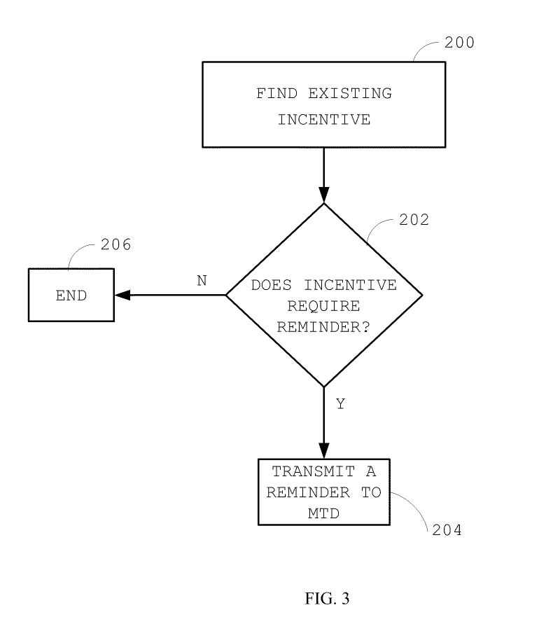

Referring to FIGS. 1 and 3, the CID 24 finds existing incentive offer in step 200. CID 24 finds the existing financial incentive offers that were delivered in step 110. In step 202 CID 24 determines if the financial incentive warrants sending a reminder. For example, certain financial incentives may benefit from sending a reminder if the financial incentive offer has not been redeemed as described in Step 306 within a predetermined time. If incentive warrants the reminder, in step 308 a reminder message is sent to the MTD 12. If a financial incentive does not warrant a reminder, no reminder message is sent, and the process ends in step 206. One such example of a reminder message can be sent a predetermined time before the incentive expires.

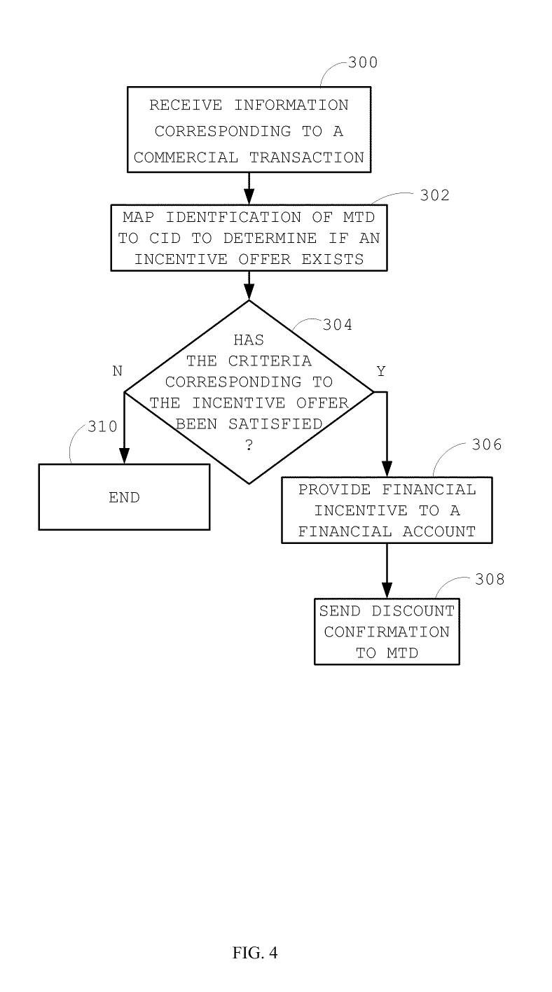

Referring to both FIGS. 1 and 4, the redemption of the incentive offer is provided directly between the owner of the financial account 45, 47 and 49 and the financial institution servicing the financial account. At step 300, CID 22 receives information corresponding to a commercial transaction that includes an incentive offer associated with MTD 12. At step 302, the identification of MTD 12 is mapped to CID 28 to determine if the incentive offer exists. At step 304 the commercial transaction is analyzed to determine whether the criteria corresponding to the incentive offer has been satisfied. Were it determined that the criteria has been satisfied, then the financial incentive is provided to the finance account, at step 306. Any type of financial incentive may be provided, such as, a cash-back discount, point accumulation and the like. Once the financial incentive is applied to the financial account, a confirmation message may be sent to MTD 12, at step 308. Additionally, the CID 28 may be updated with the particulars of the transaction during which the incentive offer was used for, inter alia, statistical analysis.

Commercial transactions found not to qualify, i.e., by failing to satisfy the criteria corresponding to the incentive offer, will result in the process ending, at step 310. Disqualification of a commercial transaction may be premised on any one or more of the criteria not being satisfied. For example, the incentive offer may be expired, the incentive offer had already been redeemed; the wrong financial account may be used to complete the transaction and/or an improper product/service is the subject of the transaction; the wrong merchant was used to complete the transaction, and the like.

It should be understood that the foregoing description is merely and example of the present invention. Many modifications and changes may be made to the foregoing descriptions while being within the spirit of the invention. Therefore, the scope of the appended claims should be interpreted in accordance with the following claims, including the full scope of equivalents thereof.

1. A method, implemented on an electronic communication network including a mobile telecommunications device, for providing financial incentives comprising:
associating said mobile telecommunications device with an incentive account; and
messaging with said mobile telecommunications device in response to one or more predetermined triggers, with said messaging including information corresponding to a financial incentive provided through a financial account associated with said incentive account upon an occurrence of a desired commercial transaction satisfying predetermined criteria; and
correlating information related to said financial account, said incentive account, and occurrence of said desired commercial transaction to determine whether said predetermined financial incentive criteria are satisfied by said desired commercial transaction; and
processing said determination result for further action in awarding or withholding said financial incentive in accordance with said financial incentive criteria.

2. The method as recited in claim 1 wherein messaging further includes transmission of a notice of said financial incentive to said mobile telecommunications device and receiving, in response to said notice, a message indicating desire for said financial incentive.

3. The method as recited in claim 1 wherein messaging further includes additional communications related to said financial incentive, selectively comprising predetermined reminders, expiration notifications, or extensions of said financial incentives.

4. The method as recited in claim 1 wherein messaging further includes defining said predetermined trigger as a passage of an interval of time.

5. The method as recited in claim 1 wherein messaging further includes defining said predetermined trigger as the occurrence of a calendar date.

6. The method as recited in claim 1 wherein messaging further includes defining said predetermined trigger as satisfaction of an initial commercial transaction at a POS terminal within a desired spatial location with respect to an additional POS terminal.

7. The method as recited in claim 1 wherein messaging further includes defining said criteria to include completing said desired commercial transaction within a predefined geographical range and/or temporal interval from said predetermined trigger.

8. The method as recited in claim 1 wherein messaging further includes defining said criteria to include completing said desired commercial transaction having a value satisfying a predefined threshold amount.

9. The method as recited in claim 1 wherein messaging further includes defining said criteria to include completing said desired commercial transaction at a predefined commercial establishment.

10. The method as recited in claim 1 wherein messaging further includes defining said criteria to include completing said desired commercial transaction a predefined number of times while satisfying the remaining predefined criteria.

11. The method as recited in claim 1 wherein awarding said financial incentive comprises the issuance of a credit or payment to one or more financial accounts associated with said incentive account.

12. The method as recited in claim 1 wherein messaging further includes communicating said messages employing one of set of messaging protocols selected from the set consisting essentially of short message service, multimedia message service, and WAP Push.

13. The method as recited in claim 1 further including providing said mobile telecommunications device selected from a set of devices consisting essentially of a cellular telephone, a wireless hand held device and a mobile computing system.

14. A system for providing financial incentives over a communication network, said system comprising:
a processor; and
stored sequences of instructions which, when executed by said processor, cause the processor to carry out the steps of:
associating said mobile telecommunications device with an incentive account; and
messaging with said mobile telecommunications device in response to one or more predetermined triggers, with said messaging including information corresponding to a financial incentive provided through a financial account associated with said incentive account upon an occurrence of a desired commercial transaction satisfying predetermined criteria; and
correlating information related to said financial account, said incentive account, and occurrence of said desired commercial transaction to determine whether said predetermined financial incentive criteria are satisfied by said desired commercial transaction; and
processing said determination result for further action in awarding or withholding said financial incentive in accordance with said financial incentive criteria.

15. The system as recited in claim 14 wherein said stored sequence of instructions further includes a subroutine to transmit a notice of said financial incentive to said mobile telecommunications device and receive, in response to said notice, a message indicating a desire for said financial incentive.

16. The system as recited in claim 14 wherein said stored sequence of instructions further includes a subroutine to selectively process further messaging related to said financial incentive, comprising predetermined reminders, expiration notifications, or extensions of said financial incentives.

17. The system as recited in claim 14 wherein said stored sequence of instructions further includes a subroutine to define said predetermined trigger as a passage of an interval of time.

18. The system as recited in claim 14 wherein said stored sequence of instructions further includes a subroutine to define said predetermined trigger as an occurrence of a calendar date.

19. The system as recited in claim 14 wherein said stored sequence of instructions further includes a subroutine to define said predetermined trigger as satisfaction of an initial commercial at a POS terminal within a desired spatial location with respect to an additional POS terminal.

20. The system as recited in claim 14 wherein said stored sequence of instructions further includes a subroutine to define said criteria to include completing said desired commercial transaction within a predefined geographical range and/or temporal interval from said predetermined trigger.

21. The system as recited in claim 14 wherein said stored sequence of instructions further includes a subroutine to define said criteria to include completing said desired commercial transaction with a value satisfying a predefined threshold amount.

22. The system as recited in claim 14 wherein said stored sequence of instructions further includes a subroutine to define said criteria to include completing said desired commercial transaction at a predefined commercial establishment.

23. The system as recited in claim 14 wherein said stored sequence of instructions further includes a subroutine to define said criteria to include completing said desired commercial transaction a predefined number of times while satisfying the remaining predefined criteria.

24. The system as recited in claim 14 wherein said stored sequence of instructions further includes a subroutine to award said financial incentive comprising the issuance of a credit or payment to one or more financial accounts associated with said incentive account.

25. The system as recited in claim 14 wherein said stored sequence of instructions further includes a subroutine to transmit said messages employing one of a set of messaging protocols selected from the set consisting essentially of short message service, multimedia message service, and WAP Push.
